(19) United States
(12) Patent Application Publication
(10) Pub. No.: US 2011/0130863 A1
(43) Pub. Date: Jun. 2, 2011

(54) METHOD FOR CONTROLLING A CRANE

(75) Inventors: Mikko Porma, Vantaa (FI); Jarno Hoffrén, Jarvenpaa (FI)

(73) Assignee: KONECRANES PLC, Hyvinkaa (FI)

(21) Appl. No.: 12/674,785

(22) PCT Filed: Aug. 21, 2008
(86) PCT No.: PCT/FI08/50471

§ 371 Date: Feb. 23, 2010

(30) Foreign Application Priority Data
Aug. 24, 2007 (FI) 20075584

(51) Int. Cl. B66C 13/22; G06F 17/00

(52) U.S. Cl. 700/213; 254/334

(57) ABSTRACT

A method for controlling a crane includes controlling a rope part connected to a hook of the crane with a friction-operated driving wheel, extra rope being coiled into a plurality of layers onto a storage reel. In the method, two machineries are used, of which the first is intended for the driving wheel and the other for the storage reel, one machinery being controlled with a speed instruction and the other machinery with a torque instruction.

### BACKGROUND OF THE INVENTION

The present invention relates to a method for controlling a crane, the method comprising controlling a rope part connected to a hook of the crane with a friction-operated driving wheel, extra rope being coiled into a plurality of layers onto a storage reel, whereby two machineries are used, of which the first is intended for the driving wheel and the other for the storage reel.

In lifting devices, the hoisting rope is generally coiled onto a drum in one layer when the lifting hook is in an upper position. However, solutions are also known, wherein extra rope is coiled onto a storage reel. In these solutions, sufficient friction is accomplished by means of the driving wheel and a sheave, whereby only a slight force, generated by means of a spiral spring, for example, is required for tightening the rope on the storage wheel. One solution is to coil the rope directly into a plurality of layers onto the driving drum.

However, particularly at extreme lifting heights, the rope drum becomes long if the rope is in one layer. This being so, a large space is required for the drum, and strong structures are required strength-theoretically. The length of the drum also makes the rope wander depending on the height of the hook. In drum solutions, the rope angle becomes large, shortening the operating life of the rope. A rope angle refers to the angle of departure from the driving wheel or the drum. Using a storage reel in the above described manner results in a large torque in the driving wheel machinery. However, managing the storage reel requires some kind of device for adjusting the tightness of the rope. A spiral spring causes difficulties if the lifting height is large. A lifting device coiling directly onto the drum into a plurality of layers also requires a large torque. Furthermore, the operating life of the rope is poor, since the rope is wound onto the reel with a high force.

### SUMMARY OF THE INVENTION

An object of the present invention is to eliminate the above-described drawbacks. This object is achieved by the method of the invention, characterized by controlling one of the machineries with a speed instruction and the other machinery with a torque instruction.

The invention is based on the use of two machineries. The machinery comprises an electric motor and generally a gear. A gearless solution is also feasible. One of the machineries drives a friction-operated driving wheel and the second machinery drives a storage reel that coils into a plurality of layers. The machinery controlling the driving wheel is preferably adjusted with the speed instruction and the machinery of the storage reel is controlled with the torque instruction. The speed instruction is supplied by the user of the lifting device or the computer controlling the operation. The speed instruction controls the speed of the lifting hook.

The method of the present invention provides the storage reel with an efficient mechanism for adjusting the tightness of the rope and, at the same time, a smaller torque of the friction-operated driving wheel is accomplished than in the prior art. A compact and strength-theoretically preferable structure is also accomplished. The rope angle is avoided, and thus the operating life of the rope improves. The position of the rope does not either wander in the device of the invention as a function of the lifting height. In the invention, the operating life of the rope is lengthened by the smaller tension force of the rope on the storage reel than in a lifting device winding directly onto the reel.

In a preferred embodiment of the method of the invention, the torque instruction of the storage reel is changed when transferring from one layer of the rope to another such that the force in the rope portion between the storage reel and the friction driving wheel remains constant. Furthermore, the force of the rope between the friction driving wheel and the storage reel is kept at half the value of that in the rope portion going from the friction driving wheel to the hook. However, a different kind of relationship can also be used. The torque changes when the rope changes layers on the storage reel. If a shift to an additional layer is made, then the torque has to increase, and if the layer decreases, then the torque decreases. In order to manage the change point of the rope layer, a table including the change point of the layer as a function of location has to be stored in a memory of the computer controlling the machineries. This information is easiest to obtain by a teaching run. The teaching run is carried out in connection with the implementation of the apparatus.

In another alternative embodiment of the method of the invention, the storage reel is controlled with the speed instruction and the driving wheel with the torque instruction. This being so, the controlling computer includes a table for changing the speed of rotation of the storage reel as a function of the length of the rope such that the speed of the hook stays in the magnitude of the speed instruction given.

Preferred embodiments of the device of the invention are disclosed in the accompanying claims 2 to 9.

### LIST OF THE FIGURES

In the following, the invention will be described in more detail in connection with a crane preferably used in the method of the invention with reference to the accompanying figures, in which

FIG. 1 illustrates the structure of a crane used in the method of the invention,

FIGS. 2A and 2B illustrate the structure of a storage reel,

FIG. 3 illustrates a speed instruction, and

FIG. 4 shows a block diagram of the mutual communication between a computer and electronics for adjusting the control of the machineries of a crane of the invention.

### DETAILED DESCRIPTION OF THE INVENTION

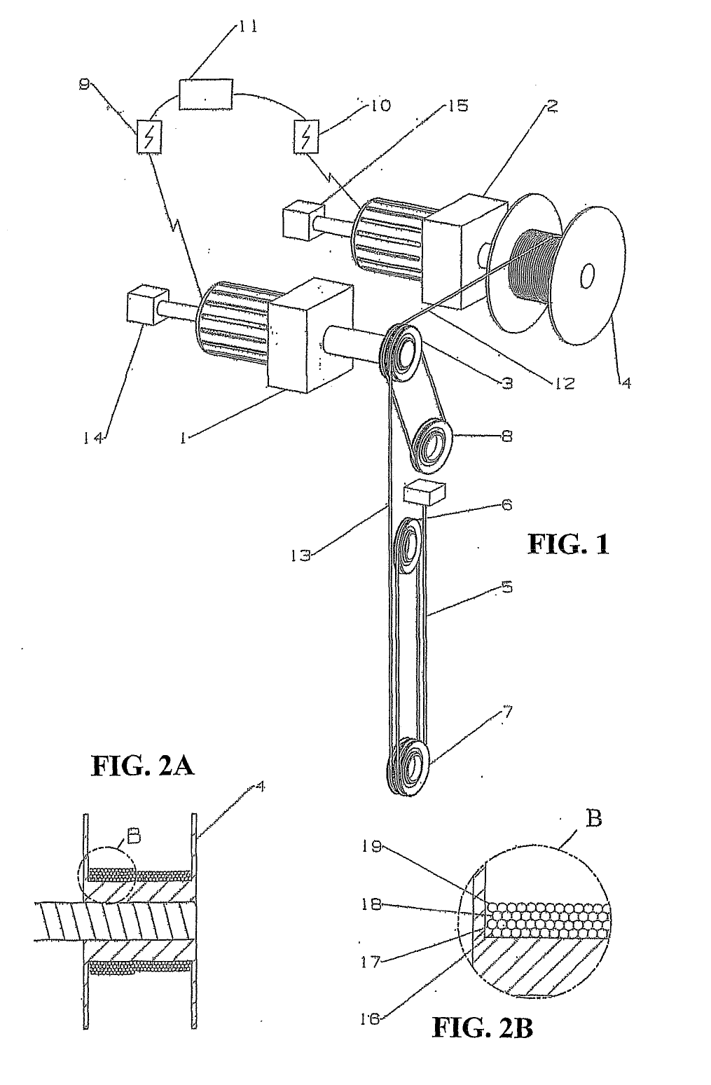

FIG. 1 shows the structure of a crane used in the method of the invention in more detail. Parts 1 and 2 operate as machineries. Machinery 1 is driven by electric drive 9 and machinery 2 is driven by electric drive 10. The electric drives are typically frequency converter drives, but direct-current drives can be used to implement a similar invention. Machinery 1 drives a friction-operated driving wheel 3 and machinery 2 drives a storage reel 4. A sheave 8 is required to obtain a sufficiently large gripping angle for the rope. Increasing the gripping angle increases the friction force. Sheave systems 6 and 7 constitute a conventional rope transmission for decreasing the rope force required. The hook (not shown) of the crane is fastened to the lower sheave system 7. A part 5 of the rope is fastened to a fixed point in the upper structure of the crane. The shafts of the machineries comprise angle sensors 14 and 15, which supply the speed information and the location information of the machineries. The location information is required in connection with the teaching program, in particular. The sensors 14 and 15 detect the change of the speed when the rope layer changes. This structure produces a contact angle of 270 to 360 degrees. By observing FIG. 1, the rope first circulates around the driving wheel 3 and then around the freely rotating sheave 7, and then reaches again the driving wheel 3. It can be seen that the effective contact angle of the driving wheel 3 is 270 degrees. It can be seen that by placing the storage reel 4 in another manner, a contact angle of 360 to 540 degrees, for example, can be obtained. However, herein it is essential that the contact angle remains small. If the reel 4 were not of the pulling type, then the contact angle required would be about 1000 degrees for the friction force to be sufficient, as is general in the prior art. Now, when the reel 4 draws, the friction force required by the driving wheel 3 is smaller by about one half than without a drawing reel. This is why the contact angle may be within a range of 270 to 540 degrees. In addition, semicircular grooves without undercutting can be used. In this case, the chafing of the rope during drawing is relatively slight. This improves the operating life of the ropes. The shaft force on the driving wheel is also reasonable.

The operating strategy is made such that the force in the rope portion 12 between the friction driving wheel 3 and the storage reel 4 is in a determined relationship to the force of the rope 13 between the friction driving wheel 3 and the hook. This relationship is one half, for example, but some other relationship may also be used. This is adjusted by suitably adjusting the force of the rope part 12. When it is desirable to generate a constant force in the rope going to the reel 4 that coils into a plurality of layers, then a different torque is required on the shaft of the reel 4, depending on the amount of rope on the reel 4 and, further, on the rope layer being used. This is because the radius between the shaft of the reel 4 and the rope changes as the amount of rope changes. The radius always increases when a new layer starts to be built on the reel 4. This is why a change in the torque instruction is required in the controlling computer. In order for this to succeed, the computer controlling the device has to know when the turn of the rope being coiled onto the reel 4 changes. To get this information, a teaching program is used in the computer. The teaching run is carried out at a constant speed of the machinery 2. In this case, the machinery 1 drives with a small torque instruction. This being so, the crane drives at a constant speed, controlled by the computer 11, from one end of a lifting movement to the other. In this case, the speed of the machinery 1 always changes when the rope starts to be coiled onto a new layer. The computer 11 monitors the location and the speed by means of the sensors 14 and 15 on the shafts of the machineries. The detection point of the change is stored in the memory of the computer. This results in a table by means of which the torque changes required by the storage reel 4 can be managed in normal operation. In normal drive, this layer information is used to change the torque of the machinery 2 in a manner keeping the rope force constant. The rope part 13 connected to the hook of the crane is controlled with a friction-operated driving wheel, and extra rope is coiled into a plurality of layers onto the storage reel 4.

FIG. 2 shows the structure of a storage reel. The different layers of rope are designated by numbers 16, 17, 18 and 19.

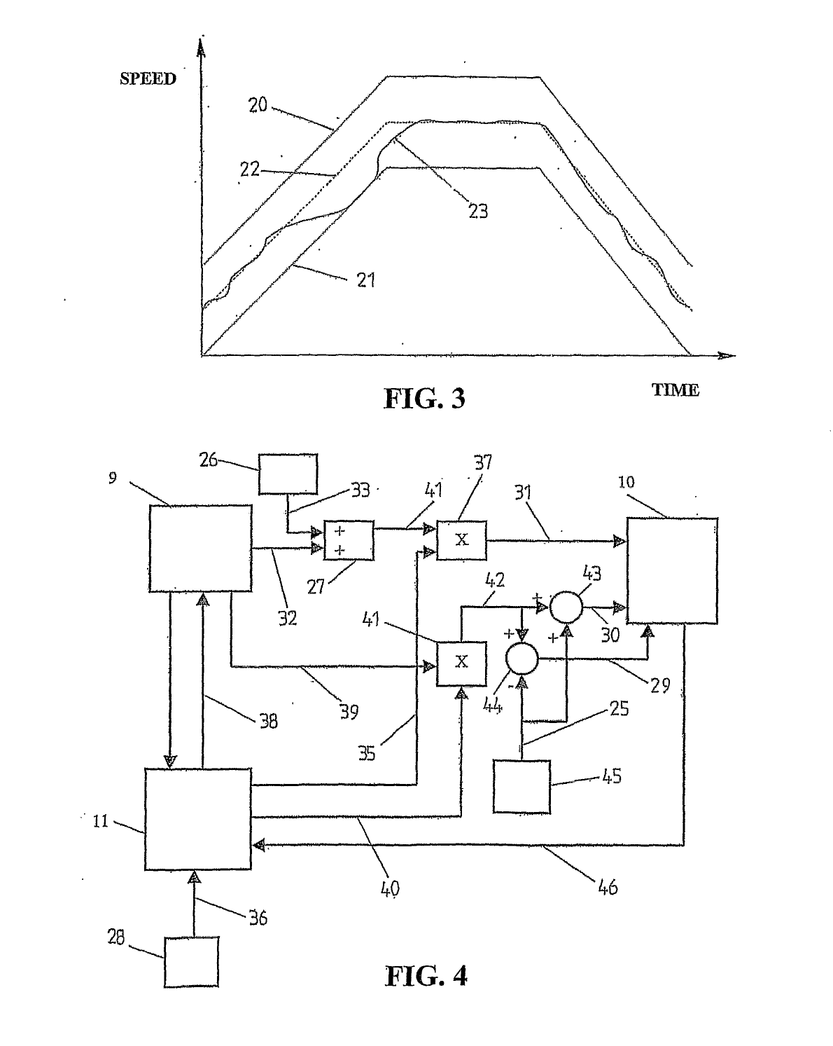

FIG. 3 shows a speed instruction tunnel 20 and 21. In FIG. 3, the speed instruction 22 receives different values from positive to negative. Curve 23 shows a realized speed instruction, which also indicates rope slip at a negative speed. in this case, the slip is managed by the speed instruction colliding with the wall of the speed instruction tunnel. The slip is mainly generated in the case of a small load or when driving without load. In this case, the slip can be managed by increasing the torque on the storage reel 4. However, in this case, the need for a total torque is small and the storage reel affords an increase in the torque.

In FIG. 4, block 28 shows a speed instruction coming from a user or other control, the speed instruction propagating along a signal 36 along the apparatus to the controlling computer 11. The computer further gives a speed instruction 38 to the electric drive 9 of the driving wheel 3. The drive of the driving wheel 3 observes the torque caused by the load and sends it further to an addition member 27 by means of a signal 32. In addition, pre-tightening information 26 arrives at the addition member 27 along a signal 33. Said pre-tightening information is required if there is no load in order for the rope 12 between the driving wheel 3 and the storage reel 4 not to loosen. If the rope 12 loosens, it interferes with the controlled coiling of the rope onto the storage reel 4. When there is load in the lifting device, then the pre-tightening may be zero. A torque instruction, corrected with the pre-tightening information, goes to a multiplication member 37. As a second factor, a torque division coefficient 35 arrives at this member. The computer 11 computes this coefficient in such a manner that the ratio of the rope forces in the rope portions 12 and 13 remains as desired. A final torque instruction 31 goes from the multiplication member 37 to the electric drive 10 of the storage reel. The storage reel 4 gives its location information 46 to the controlling computer 11. The computer utilizes said location information to note the change point of the rope layer. When a change point occurs, the computer changes the torque division coefficient 35. To make a speed instruction tunnel, the computer 11 computes speed information 42 suitable for the storage reel 4. This is derived from the speed 39 of the driving wheel 3, which is corrected by a speed coefficient 40 in a multiplication member 41. The coefficient 40 depends on the state of the storage reel 4 and the layer therein. An allowed speed tolerance 45 is added to said speed information along a signal 25 in an addition member 43. This yields the upper edge 30 of the speed instruction tunnel. In a corresponding manner, a speed tolerance is subtracted from the speed information 42 in a difference member 44, yielding a lower limit 29 for the speed instruction tunnel. If the rope slips, and the edge of the speed instruction tunnel is reached, the storage reel 4 increases its torque in order for the rope not to slip further.

It is to be understood that the foregoing description and the thereto-related figures are only intended to illustrate the present invention. Different variations and modifications of the invention will be evident to a person skilled in the art without deviating from the scope of protection and the spirit of the invention disclosed in the enclosed claims.

1. A method for controlling a crane, the method comprising the steps of:
controlling a rope part connected to a hook of the crane with a friction-operated driving wheel, extra rope being coiled into a plurality of layers onto a storage reel, whereby two machineries are used, of which the first is intended for the driving wheel and the other for the storage reel; and
controlling one of the machineries with a speed instruction and the other machinery with a torque instruction.

2. A method as claimed in claim 1, further comprising the step of controlling the machinery driving the driving wheel with a speed instruction and the machinery driving the storage reel with a torque instruction.

3. A method as claimed in claim 1, further comprising the step of controlling the machinery driving the driving wheel with a torque instruction and the machinery driving the storage reel with a speed instruction.

4. A method as claimed in claim 1, further comprising the step of controlling the crane with a common computer that controls both machineries and manages their mutual dependencies.

5. A method as claimed in claim 1, further comprising the step of controlling the crane with a common computer that simultaneously controls motor-drives of one or both of the machineries.

6. A method as claimed in claim 1, further comprising the steps of:
storing a table according to the lifting height in a memory of a controlling computer; and
adjusting the torque of the storage reel by means of the table in a manner keeping the rope force constant.

7. A method as claimed in claim 4, further comprising composing a table managing the rope layers according to the lifting height automatically by means of a teaching program stored in the computer.

8. A method as claimed in claim 1, further comprising the step of managing the rope slip of the driving wheel by increasing the torque of the storage reel if the speed does not remain in a speed tunnel.

9. A method as claimed in claim 1, further comprising the step of arranging a contact angle of 270 to 540 degrees for the rope by means of a sheave and the driving wheel.
